(19) United States
(12) Patent Application Publication
(10) Pub. No.: US 2022/0357841 A1
(43) Pub. Date: Nov. 10, 2022

(54) SYSTEM AND METHOD FOR PARALLEL MULTI-COLUMN TEXT PRESENTATION AND EDITING ON A COMPUTER DISPLAY

(71) Applicant: THEBRAIN TECHNOLOGIES LP, Los Angeles, CA (US)

(72) Inventor: Harlan HUGH, Los Angeles, CA (US)

(21) Appl. No.: 17/738,815

(22) Filed: May 6, 2022

Related U.S. Application Data
(60) Provisional application No. 63/185,501, filed on May 7, 2021.

(51) Int. Cl. G06F 3/04855; G06F 3/0482; G06F 40/106

(52) U.S. Cl. CPC G06F 3/04855; G06F 3/0482; G06F 40/106

(57) ABSTRACT

Provided are methods and systems for displaying and editing text on computer hardware monitors and screens (“computer displays”) that utilize horizontal space effectively while enabling seamless scrolling through content.

### CROSS-REFERENCE TO RELATED APPLICATIONS

This application claims the benefit of U.S. Provisional Application No. 63/185,501 entitled “System and Method for Parallel Multi-Column Text Presentation and Editing on a Computer Display,” filed May 7, 2021. The entirety of the foregoing application is incorporated herein by this reference.

### FIELD OF DISCLOSURE

This disclosure relates in general to displaying text on computer displays to users in a highly readable and easily editable way.

### BACKGROUND

When editing text on a computer display, it may be beneficial for a reader to see as much of the document as possible while maintaining a reasonable font size. As text is typically laid out in rows, the most basic approach is to make those rows extend to the edges of the available space. However, when the computer display is wide, that approach adds difficulty to reading the text, as long horizontal lines of text make it difficult for the reader to find the next line when moving the user's eyes from the end of one row on the right side of the text to the start of the next row on the left side. When the rows are too long, the user can easily lose track of which line the user just completed and which one is next. Adding margins to the sides of the text may increase readability, but may decrease the available space for text that can be presented.

To avoid the problem of rows of text that are too long while utilizing the available width, displays can arrange the text into multiple columns. This involves dividing the available space up into columns of suitable width, starting with the leftmost column and filling it with successive rows until the end of the available vertical space is reached at which point the process continues in the next column. The result may be full utilization of the available screen space on the computer display giving the user the ability to see much more at once. However, if all of the content cannot fit into the available computer display space despite the use of multiple columns, two approaches may be used, i.e., the paging mechanic and the horizontal scrolling mechanic.

The paging mechanic replicates reading in print format—newspapers and magazines have long utilized columns sometimes spread across multiple pages to make reading easier. In accordance with this approach, the currently-displayed text on a computer screen may be treated as a “page” and the user may navigate to the next page via a button or scroll bar, for example. When the next page is displayed on the computer screen, the text layout process may clear all of the text from the previous page and may resume the layout of the remaining text starting again from the leftmost column.

A major problem with trying to adapt the paging mechanic approach to a computer display is that there is no fractional position possible between pages. Each new page that is displayed is a complete shift from the prior page that was displayed. Changing pages may result in the reader having to use more mental energy, as the reader must remember what was on the prior displayed page and cannot see the ending content from the previous page and the beginning content from the current displayed at the same time—there is no way for a reader to see the entirety of a concept that may be arbitrarily broken up between two pages, for example.

In print magazines and newspapers, static text may be laid out on fixed-size paper and page and column breaks can be carefully decided. But on a computer display, the appropriate breaking points are not known—a problem unique to displaying text on computer displays. Even more problematic, computer displays may have different dimensions, and may use different fonts and font sizes. And the text itself may be changed as the user edits it. So, the places where the page breaks occur can change dynamically.

This problem with computer displays may be exacerbated when editing or selecting digital text—as a user begins typing or making a selection near the end of a digitally-displayed page, eventually, the next word or character that is typed or selected will appear on the next displayed page due to page breaks. Thus, it may not be possible to read or select the complete sentence the user is working on without scrolling, swiping, or clicking back and forth between digital pages, and selecting the entire sentence in a single user action may be impossible. For example, attempting to select a sentence that begins at the end of a first column by clicking and moving the cursor downward, rather than upward and to the top of the next column, may inadvertently select the entire page of content and move to the first column of the next page, rather than just selecting the desired sentence.

Another existing approach for dealing with the above-described issues, but one that is not widely adopted, is for a computer display to utilize a horizontal scrolling mechanic. In this approach, the amount of horizontal space is extended to add more columns in a virtual plane that is accessible via scrolling right and left in the computer display. With this approach, it is possible to scroll one column at a time.

While this approach attempts to resolve the major shift that comes with moving from page to page in a computer display, the horizontal scrolling mechanic does not fix the issue—column breaks unnaturally break up text, just like page breaks. A concept that starts at the bottom of one column and ends at the top of the next column may be visually separated by a significant physical distance on the computer display despite being logically connected. This causes problems for the user when editing and selecting text across multiple columns.

### SUMMARY

Comfortable reading requires that lines of text not exceed a width that can be easily scanned by a reader's eye. However, the width of many computer displays exceeds this threshold. As a result, the width of text presented to the user may be limited and much of the display may remain unused—a problem unique to computer displays, since they are designed to display any images or text regardless of width, unlike text typeset on paper of a defined width. Aspects of the disclosure relate to computer displays with a multi-column graphical user interface that may be seamlessly scrollable to enable easier reading, selecting and editing of text for the user.

### BRIEF DESCRIPTION OF THE DRAWINGS

Aspects of the disclosure are illustrated by way of example, and not by way of limitation, in the figures of the accompanying drawings and in which like reference numerals refer to similar elements, and in which:

FIG. 1 shows an example illustration of a graphical user interface on a computer display with text laid out in a parallel multi-column scrolling arrangement.

FIG. 2 shows an example illustration indicating the order of movement of the columns of text displayed in the graphical user interface.

FIG. 3 shows an example illustration of the end result of how the displayed text moves on in a graphical user interface when a user scrolls down.

FIG. 4 shows an example illustration of an expanded view of how text may be displayed, may be moved, and may be queued on a column-by-column basis in a graphical user interface laid out in a parallel multi-column scrolling arrangement.

FIG. 5 shows an example illustration of an expanded view of how text moves from one column to the next in the graphical user interface when a user scrolls down.

FIG. 6 shows a method for displaying and editing content in accordance with aspects of the present disclosure.

FIG. 7 illustrates an example of a general purpose computer system on which aspects of the present disclosure can be implemented.

FIG. 8 shows a block diagram of various example system components, in accordance with aspects of the disclosure.

### DETAILED DESCRIPTION

Aspects of the disclosure will now be described in detail with reference to a few preferred aspects thereof as illustrated in the accompanying drawings. In the following description, numerous specific details are set forth in order to provide a thorough understanding thereof. It will be apparent, however, to one skilled in the art, that aspects of the present disclosure may be practiced without some or all of these specific details. In other instances, well known process steps or structures have not been described in detail in order to not unnecessarily obscure description thereof.

In an aspect of the present disclosure, a new way to lay out text or other content on a computer display into multiple columns that allows the user to utilize vertical scrolling in combination with multiple columns without resorting to paging is described. The text or other content can be from any digital source—a web browser, e-book, online article, webpage, a .pdf file, etc. That other content, by way of example, can include without limitation, photographs, charts, drawings, musical notation, symbols, video, slide shows or other audiovisual works or any other type of graphic or media that a user can perceive. In the descriptions and figures, text may be referred to, but that is by way of example only, as aspects of the present disclosure can be practiced with text or any other content.

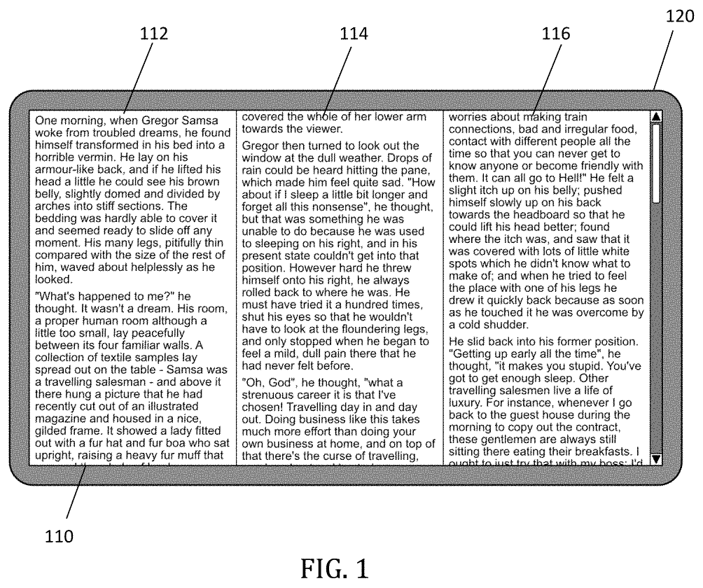

The text or other content displayed on the computer display may be organized in a graphical user interface 110 into columns 112, 114, 116 as shown in FIG. 1, and the end of the first column 112 may continue at the top of the next column 114 until there are no more columns visible on the computer display 120. To see more content on the computer display 120, the user may scroll vertically in the graphical user interface 110 and the text and content from all of the columns 112, 114, 116 continues uninterrupted.

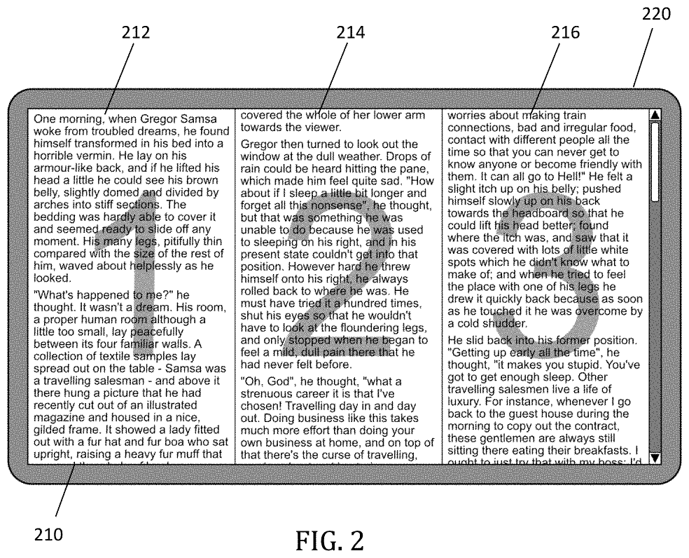

FIG. 2 shows an example illustration indicating the order of movement of the columns of text displayed in the graphical user interface. As shown in FIG. 2, when the user scrolls down the displayed content by one row in the first column 212 of the graphical user interface 210, the content in all of the other columns 214, 216 shown on the computer display 220 in the graphical user interface may shift up by one row. For example, the bottom of Column 1 212 may now display the line that was formerly at the top of Column 2 214. The bottom of Column 2 214 may display the line that was at the top of Column 3 216 and the bottom of Column 3 216 may display content that was not previously shown in the graphical user interface 210 on the computer display 220.

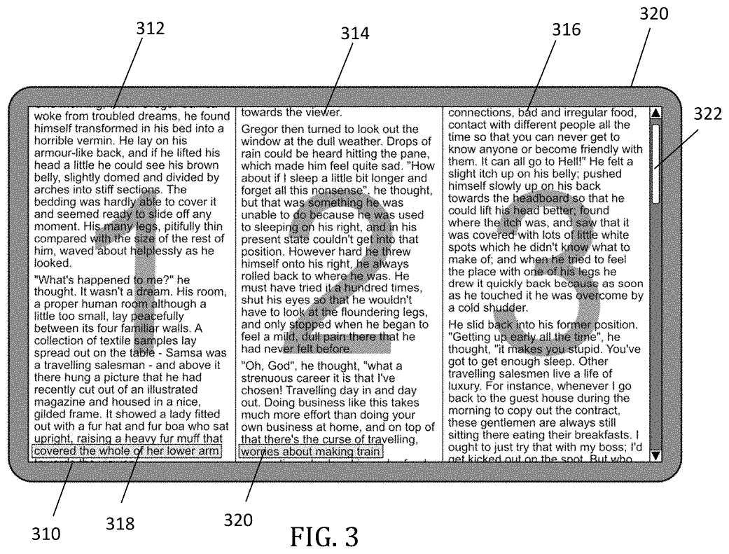

FIG. 3 shows an example arrangement of the content in the graphical user 310 interface after a user scrolls down by one row from the position of the text in FIG. 2. The highlighted line, “covered the whole of her lower arm,” 318 may be added as the lowest line at the bottom of Column 1 312 and deleted from the top of Column 2 314. And the highlighted line, “worries about making train,” 320 may be deleted from the top of Column 3 316 and added as the lowest line at the bottom of Column 2 314.

Conversely, if the user scrolls up 322 by one row, all of the columns 312, 314, 316 in the graphical user interface 310 may shift down by one row. For example, the top of Column 1 312 may now display content that was previously not shown in the graphical user interface 310. The top of Column 2 314 may display content that was previously at the bottom of Column 1 316. The top of Column 3 316 may display content that was previously at the bottom of Column 2 314.

The same principle may apply to scrolling by any arbitrary amount including fractions of rows. All of the columns 312, 314, 316 may scroll in parallel at the same rate and in the same direction as the columns may be replicas of one another, and may be offset in their placement in the graphical user interface 310 on the computer display 320.

In accordance with one aspect, the display of content in columns according to parameters set by the user, or by other computers or computer programs, may be customized. Example parameters may include, without limitation:
a. The number of columns;
b. The order of columns—e.g. right to left, left to right, high and low;
c. The width of columns;
d. Arrangement of scrolling text, including permitting hyphenation, or moving hyphenated words separately or as one unit;
e. “widow and orphan” control wherein groups of content such as sentences, paragraphs, entire graphics or photographs, are kepot together in a single column and only scrolled from one to column to another as a single unit, when space in the other column permits;
f. Justifying text—right, left or fully justified;
g. Text or content size within one or more columns.

In variations accommodating left-to-right written languages like English, a first column could be on the left of the graphical user display and second and subsequent columns could be to the right of each other. And in variations accommodating right-to-left written languages like Arabic or Aramaic, a first column could be on the right of the graphical user display and second and subsequent columns could be to the left of each other.

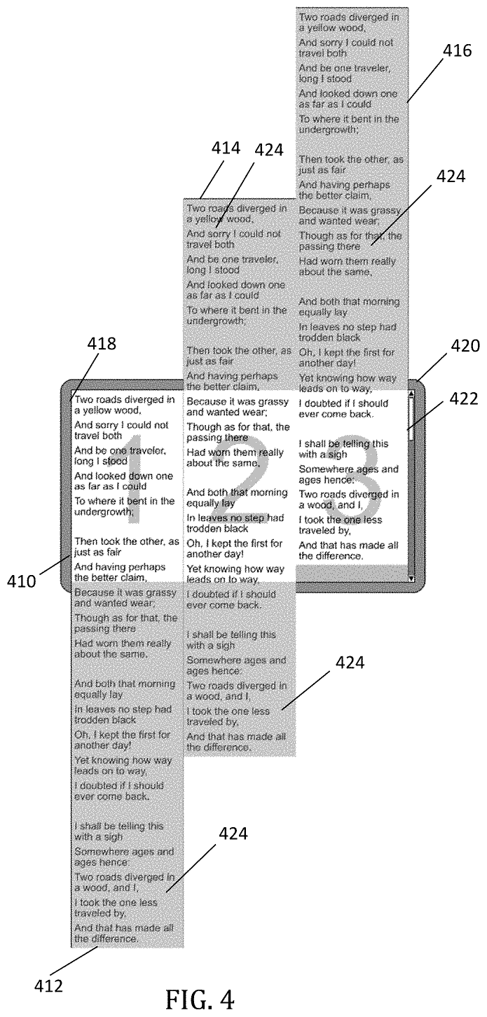

FIG. 4 shows an example illustration of an expanded view of how text may be displayed, may be moved, and may be queued on a column-by-column basis in a graphical user interface laid out in a parallel multi-column scrolling arrangement. As shown in FIG. 4, the task of arranging the content in a graphical user interface 410 on a computer display 420 may be performed by arranging all of the text or content in the graphical user interface into a single column 412 that may have the height necessary to contain all of the text while ignoring how much can actually be displayed on the computer screen.

For example, the top-left corner of this complete text column may be the origin point 418. While three columns 412, 414, 416 are shown on the graphical user interface 410 numbered 1 through 3, the number of columns can vary. In practice, the number of columns may be determined by the width of the available space on the computer display 420 divided by factors, for example—(1) the user's preferred column width; (2) default column widths; (3) column widths determined to be comfortable for the average user; (4) user's past selections of column widths; or (5) based on use case such as editing, or presentation on a large screen, or printing.

For Column 1 412, the complete text of the column may be placed in the graphical user interface 410 on the computer display 420 with the origin point 418 at the top-left corner of the computer display 420. For Column 2 414, the complete text of the column may be placed again but offset one column width to the right and one computer display height up. For Column 3 416, the complete text of the column may be placed a third time but offset two column widths to the right and two computer display heights up.

In this example, a larger font size has been utilized so that the text can be read without the need to enlarge it beyond a practical size. The gray-colored areas 424 show the portions of the complete text column that may not be visible on the computer display 420 due to being outside the bounds of the display area. When the user scrolls 422 in the graphical user interface 410, all three full columns may be moved up and down in unison.

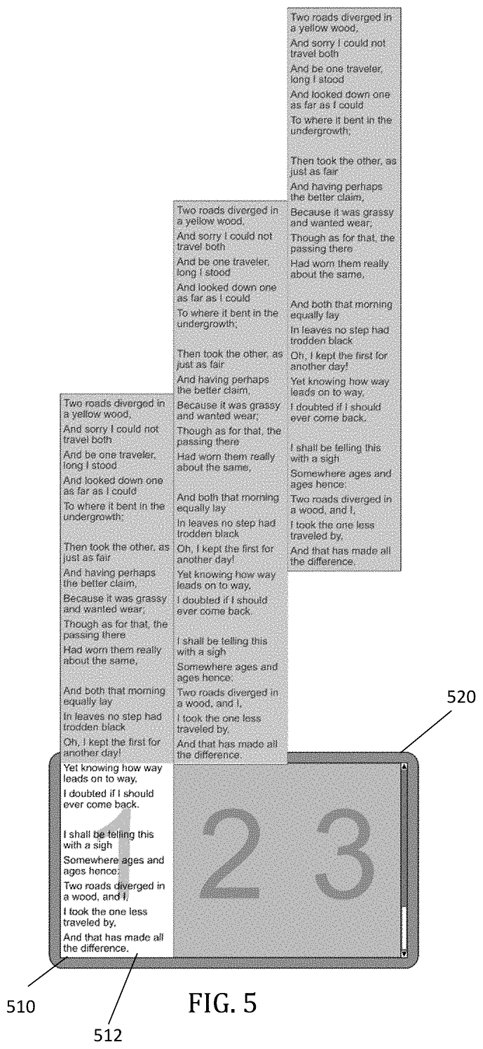

FIG. 5 shows the same content as FIG. 4, but after the user has scrolled so that the end of the displayed text may now be visible in Column 1 512 on the computer display 520. The above description is related to one example aspect of the disclosure. In another aspect, the system and method herein may ignore the portions of the complete text columns that are not visible on the computer display at any given time.

For applications made for editing text for the purpose of printing on paper, or applications in which a user needs to know where the page breaks are meant to occur in the published paper version, an aspect of the disclosure incorporates methods of indicating to the user where the print page breaks occur.

The location of page breaks may be dynamic and may be calculated based on the size of the physical output paper, margins, font size, line spacing and other applicable settings. In addition to these automatic page breaks, formatting commands may be embedded into the text to force a page break at a particular location.

Aspects of the disclosure may include indications of the location of physical page breaks via special rows that serve as visual markers. In one aspect, these markers may be rendered as dashed horizontal lines and may also include the page number. In another aspect, these marks may be rendered in other ways, such as a rectangle of a different color spanning the full width of the page.

In an aspect of the disclosure, the user may also set the width of the columns on the computer display to match that of the expected physical printed page. This matching width may cause the line breaks at the end of each row of text to occur at the same place on the computer display as it does on the physical printed page.

Aspects of the disclosure relate to a technique of laying out text or other content and scrolling that has several advantages over the prior described approaches in solving issues with showing text or other content on computer displays.

Visually being able to scroll any arbitrary amount means that smooth animation can be achieved to maintain the illusion that the computer display serves as a window into a physical surface that continues beyond the visible text shown on the computer display. This system of laying out text or other content and scrolling may better engage the user and connect the user to the content.

Since every column has complete access to all of the text, the user can work in any of the columns and scroll to find what desired content/location without the need to scan left and right across the computer display. This may eliminate the need to shift the user's gaze over physical distances across the computer display when scanning over a corpus of text. At the same, time the user can see the additional content contained in the other columns.

In aspects of the system and method herein, content may never be permanently visually separated on the computer display. While the text may break from one column to the next at the top and bottom of the computer display, the ability to scroll seamlessly enables the user to shift where that break occurs.

When writing and editing text, the advantages of this system and method are even more pronounced. Typing text or adding other content may not result in the entered text or content breaking across a column or page break and appearing physically separated on the computer display. Page breaks may not exist in this system and method. Column breaks only exist at the top and bottom of the graphical user interface on the computer display, which can be moved gradually via scrolling as the user types, e.g., text. This means that if the user enters text near the bottom of Column 1, for example, as the user reaches the bottom, the content simply scrolls upward making more room for the user to continue typing. Essentially, each column may function in the same way as a conventional single-column text editor.

When selecting text or other content, the user may utilize a pointer dragging gesture in multiple ways. First, the user may drag from any column, and as the end of the column is reached, the computer display may automatically scroll so the user can continue seamlessly continue the selection, selecting the content in order, and eliminating the variable interpretations when gestures depend on the visual layout of columns or pages. Each column may function in the same way a conventional single-column text editor does. Second, the user may start dragging in one column and move into another column. This system of selection may be preferable when a large amount of text is selected and may mirror how selecting text or content works in both the paging mechanic and the horizontal scrolling mechanic, except that at any time, the user may move the pointer to the top or bottom of the computer display to cause the text to scroll in that direction.

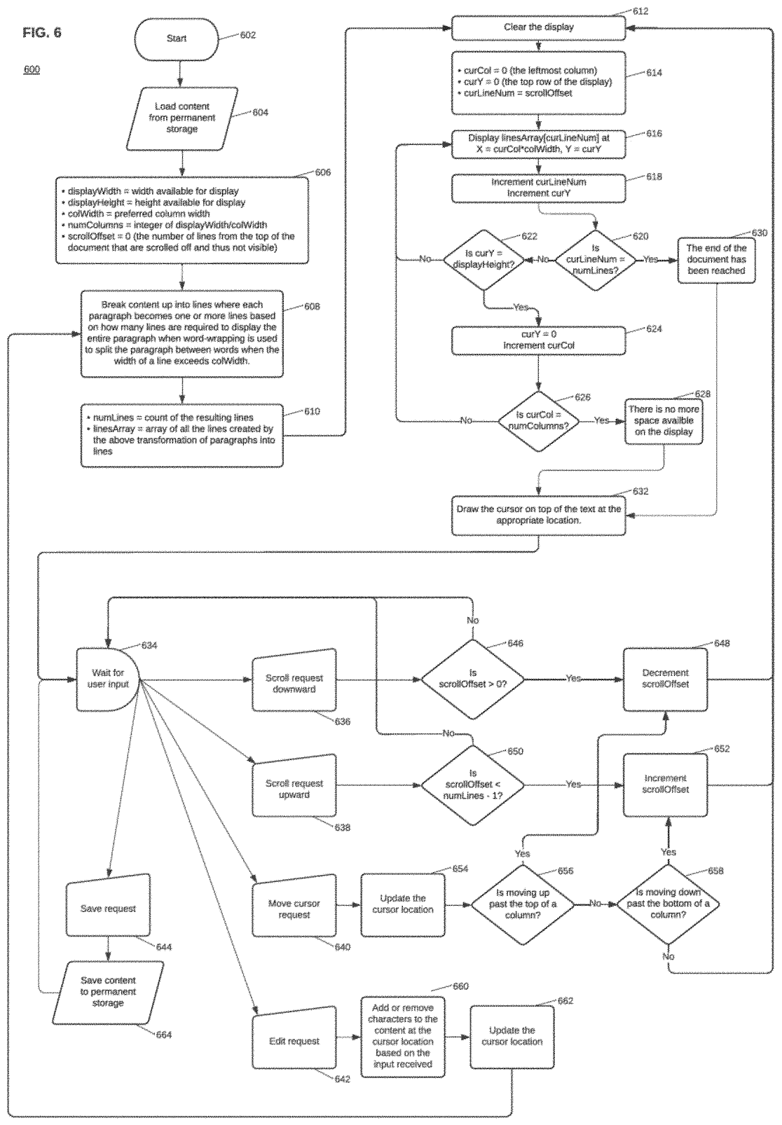

FIG. 6 shows a method for displaying and editing visual content, such as text, images or graphics, in accordance with aspects of the present disclosure. The method 600 includes aspects of the disclosure of loading a content document, preparing it for display, displaying it and allowing user interactions including scrolling, moving the cursor and editing, among other aspects. Units of measurement throughout the method 600 are simplified such that 1 unit of height is equal to the height of a line of text and 1 unit of width is equal to the width of a character. It will be recognized by those of ordinary skill in the art that variable width and height fonts as well as images of arbitrary size may be accommodated. A left-to-right language is assumed and adjustments for margins around columns are not included, although a right-to-left language and adjustments for margins around columns may be implemented.

The method starts at block 602.

At block 604, content may be loaded from permanent storage such as a hard drive and placed into memory. This data may be in a typical text format, i.e., UTF-8 characters with newline characters separating paragraphs, but alternative text formats may be used.

At block 606, working variables may be initialized based on the current settings and available display area. This process of preparing for display of the visual content may happen when the method begins, for example, or at any time the display is resized or a setting such as the preferred column width is changed, among other situations. The following variables, among others, may be set: displayWidth may be set to the width available for display. The variable displayHeight may be set to the height available for display. The variable colWidth may be set to the preferred width of a column which may be a user adjustable number likely in the range of 40 to 120 characters. The variable numColumns may be calculated by determining how many times colWidth fits inside of displayWidth, for example. In an aspect, if the division of displayWidth by colWidth includes a fractional number, that portion may be discarded or optionally the colWidth may be adjusted such that it fits more evenly within displayWidth. Finally, the variable scrollOffset may be set to zero. The variable scrollOffset may be used to track how much of the content has been scrolled up beyond the top of the display. In accordance with one aspect, if the operations at block 606 were to be repeated due to a resize of the display, for example, the variable scrollOffset may not be reset to zero.

At block 608, visual content may be prepared for display by processing the visual content from the raw characters into separate strings each representing a line of text that fits within the variable colWidth, for example. This process may be implemented in many text display systems and is commonly known as word-wrapping. Lines may be created by adding one character at a time until a newline character is encountered or the width of the line exceeds the variable colWidth, for example. When colWidth is exceeded, characters may be removed until a word-breaking character (typically a space, for example) is found. The resulting line may be stored and the process resumed until all of the visual content is split up into lines.

At block 610, the output of 608 may be stored into the variable linesArray, comprising an array of all lines created by processing the visual content into lines of text. The number of lines may be stored as the variable numLines, for example. The variable linesArraymay allow fast access to the particular piece of the visual content that occurs at any specific distance from the top of the content.

At block 612, the process of showing the content on the display begins. The display may be cleared of any previous output at this point, for example.

At block 614 variables to be used in a loop to facilitate the display of the content may be initialized. For example, variables such as curCol and curY may be used to keep track of where text will next be added to the display. These values may change as the loop proceeds. The variable curCol may represent the current column and may be set to zero, which may correspond to the leftmost column. The variable curY may represent the number of rows down from the top of the display and may also be set to zero, which may correspond to the top of the display. The variable curLineNum may be the index into linesArray of the next line of text to be added to the display. The variable curLineNum may be set to the scrollOffset to begin the loop and may be incremented as the loop progresses. As will be further detailed later, this may enable scrolling to take place by changing scrollOffset and restarting at block 612.

At block 616, the actual output of text to the display may occur. In an aspect, such output and the clearing of the display at 612 may be performed to an offscreen buffer instead of directly to the display in order to avoid flickering of the display when it is updated, among other reasons. In an aspect, the horizontal position, X, may be calculated by multiplying curCol by colWidth and the vertical position, Y, may be set to curY. The text found in linesArray at the index curLineNum may then be output at X, Y.

At block 618, curLinNum and curY may be incremented to prepare for the display of the next line.

In accordance with one aspect, at block 620, a check may be performed to determine if all of the text has been displayed (e.g., if curLineNum is equal to numLines). If all of the text has been displayed, the method proceeds to block 630, at which an indication may be provided to indicate that the entire document has been displayed. Otherwise, the method continues to block 622.

In accordance with one aspect, at block 622, a check may be performed to determine whether the current column is full (e.g., if curY is equal to displayHeight). If the current column is not full, the method returns to block 616 to continue displaying the next line of text. Otherwise, the method continues to block 624.

At block 624, the bottom of display may have been reached. The variable curY may be set to 0 and curCol may be incremented to move on to the next column.

At block 626, a check may be performed to determine if all of the columns have been filled (e.g., if curCol is equal to numColumns). If not, the method returns to block 616 to continue displaying the next column. Otherwise, the method continues to block 628.

At block 628, no further content can fit on the display and the method proceeds to block 632.

Block 632 may be reached when no more content can be displayed because there is no more content left or there is no display space left, among other reasons. At this point, additional objects may be displayed, such as the cursor which should be indicated on top of the lines that have just been output, for example.

At block 634, the display may be complete. From here, the method 600 may proceed to any of blocks 636, 638, 640, 642 or 644, each of which represents a possible event that may occur.

At block 636, a request to scroll downward may have been received and the method proceeds to block 646, where a determination is made whether it is possible to scroll downward by determining if scrollOffset is greater than zero, for example. If scrollOffset is greater than zero, at block 648, scrollOffset may be decremented and the display may be updated by proceeding to block 612. If scrollOffset is not greater than zero, the method returns to block 634.

In one aspect, at block 638, a request to scroll upward may have been received and the method proceeds to block 650, where a determination is made whether it is possible to scroll upward by determining if scrollOffset is less than numLines −1. If scrollOffset is less than numLines −1, in block 652 scrollOffset may be incremented and the display may be updated by proceeding to 612. If not, we return to 634 to await the next event.

Block 640 indicates a request to move the cursor has been received. In block 654 we update the cursor location in memory which will cause it to be displayed at the correct location later on in block 632 when the display is updated. Next in block 656 we check if the cursor is moving past the top of a column and if so we may cause an upward scroll to occur by decrementing scrollOffset at 648 and proceeding to update the display at block 612. Otherwise, at block 658, a determination may be performed as to whether the cursor may be moving past the bottom of a column and, if so, may cause a downward scroll to occur by incrementing scrollOffset at 652 and proceeding to update the display at block 612. Otherwise, the method may proceed directly to block 612 to update the display.

In an aspect, at block 642, a request to edit the text may have been received, i.e., a keyboard or other input device (such as a mouse, trackball, joystick, touchscreen, scanner, webcam or microphone, for example) signal may have been received to, e.g., add or delete a character. At block 660, the visual content may be modified at the cursor location in the data to satisfy the request. Once the modification has been made, the cursor location may be updated, i.e., moved one character to the right if a character was just added, for example. Having modified the visual content, the visual content it must be processed for display at block 608. In one variation, instead of processing the entirety of the content at 608 as was done on the first pass through blocks 608 and 610 after the initial loading, it may be more efficient to adjust the existing values of numLines and linesArray based on the modifications made at block 660.

At block 644, a request to save the content may have been received. At block 664 the content may be written back to permanent storage.

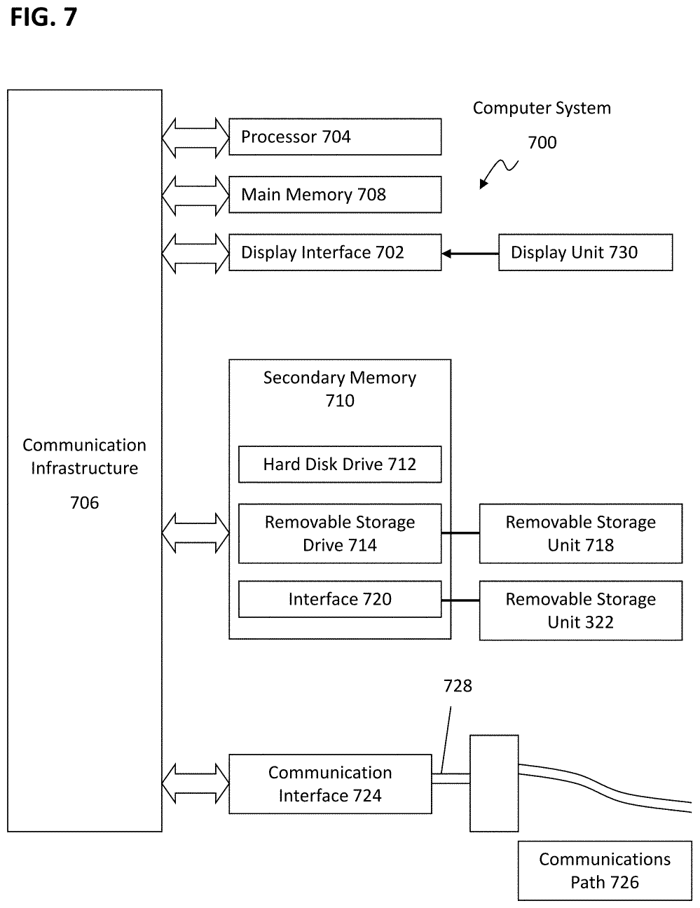

Aspects of the present disclosure may be implemented using hardware, software, or a combination thereof and may be implemented in one or more computer systems or other processing systems. In one aspect, the disclosure is directed toward one or more computer systems capable of carrying out the functionality described herein. FIG. 7 presents an example system diagram of various hardware components and other features that may be used in accordance with aspects of the present disclosure. In one exemplary variation, aspects of the disclosure are directed toward one or more computer systems capable of carrying out the functionality described herein. An example of such a computer system 700 is shown in FIG. 7.

Computer system 700 includes one or more processors, such as processor 704. The processor 704 is connected to a communication infrastructure 706 (e.g., a communications bus, cross-over bar, or network). Various software aspects are described in terms of this example computer system. After reading this description, it will become apparent to a person skilled in the relevant art(s) how to implement aspects of the disclosure using other computer systems and/or architectures.

Computer system 700 may include a display interface 702 that forwards graphics, text, and other data from the communication infrastructure 706 (or from a frame buffer not shown) for display on a display unit 730. Computer system 700 also includes a main memory 708, preferably random access memory (RAM), and may also include a secondary memory 710. The secondary memory 710 may include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc., which is read by and written to removable storage drive 714. As will be appreciated, the removable storage unit 718 includes a computer usable storage medium having stored therein computer software and/or data.

In alternative aspects, secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728, which may be electronic, electromagnetic, optical or other signals capable of being received by communications interface 724. These signals 728 are provided to communications interface 724 via a communications path (e.g., channel) 726. This path 726 carries signals 728 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 780, a hard disk installed in hard disk drive 770, and signals 728. These computer program products provide software to the computer system 700. Aspects of the disclosure are directed to such computer program products.

Computer programs (also referred to as computer control logic) are stored in main memory 708 and/or secondary memory 710. Computer programs may also be received via communications interface 724. Such computer programs, when executed, enable the computer system 700 to perform various features in accordance with aspects of the present disclosure, as discussed herein. In particular, the computer programs, when executed, enable the processor 704 to perform such features. Accordingly, such computer programs represent controllers of the computer system 700.

In variations where aspects of the disclosure are implemented using software, the software may be stored in a computer program product and loaded into computer system 700 using removable storage drive 714, hard drive 712, or communications interface 720. The control logic (software), when executed by the processor 704, causes the processor 704 to perform the functions in accordance with aspects of the disclosure as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects of the disclosure are implemented using a combination of both hardware and software.

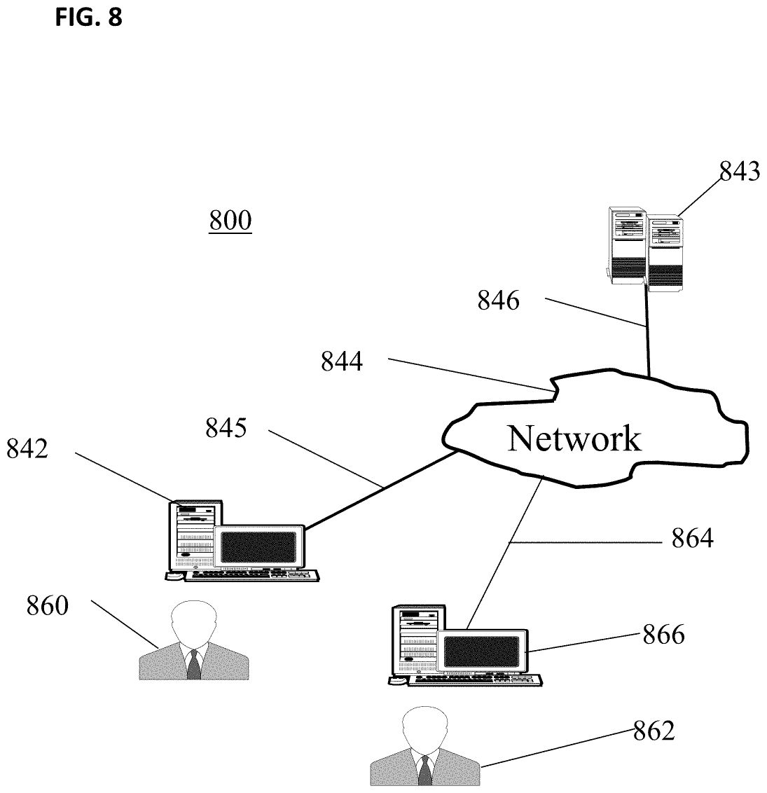

FIG. 8 is a block diagram of various example system components, in accordance with an aspect of the present disclosure. FIG. 8 shows a communication system 800 usable in accordance with the present disclosure. The communication system 800 includes one or more accessors 860, 862 (also referred to interchangeably herein as one or more “users”) and one or more terminals 842, 866. In one aspect, data for use in accordance with aspects of the present disclosure is, for example, input and/or accessed by accessors 860, 862 via terminals 842, 866, such as personal computers (PCs), minicomputers, mainframe computers, microcomputers, telephonic devices, or wireless devices, such as personal digital assistants (“PDAs”) or a hand-held wireless devices coupled to a server 843, such as a PC, minicomputer, mainframe computer, microcomputer, or other device having a processor and a repository for data and/or connection to a repository for data, via, for example, a network 844, such as the Internet or an intranet, and couplings 845, 846, 864. The couplings 845, 846, 864 include, for example, wired, wireless, or fiberoptic links. In another example variation, the method and system in accordance with aspects of the present disclosure operate in a stand-alone environment, such as on a single terminal.

1. A computer-implemented method for displaying and editing visual content, the method comprising:
storing the visual content in a memory; and
displaying the visual content on a graphical user interface in at least a first and a second column, the visual content from the first column continuing in the second column;
wherein, when a user scrolls up the visual content data displayed in the first column on the graphical user interface, a computer processor causes the visual content displayed in the second column to dynamically change to begin appearing at the bottom of the first column such that continuity of the visual content is maintained between the first and second columns.

2. The computer implemented method according to claim 1, further comprising:
preparing, via the computer processor, the visual content for display by processing the visual content from raw data into separate sets of objects each representing a line of content for display.

3. The computer implemented method according to claim 2, further comprising:
storing the separate sets of objects in the memory.

4. The computer implemented method according to claim 3, wherein the visual content has a top and a bottom; and wherein each set of objects enables access to a piece of the visual content that occurs at a specific distance from the top of the visual content.

5. The computer implemented method according to claim 2, further comprising:
storing the number of lines as a line variable in the memory.

6. A system for displaying and editing visual content, the system comprising:
a memory;
a graphical user interface; and
a computer processor communicatively coupled to the memory and the graphical user interface, the processor configured to:
store the visual content in the memory; and
display the visual content on the graphical user interface in at least a first and a second column, the visual content from the first column continuing in the second column; and
wherein, when a user scrolls up the visual content data displayed in the first column on the graphical user interface, a computer processor causes the visual content displayed in the second column to dynamically change to begin appearing at the bottom of the first column such that continuity of the visual content is maintained between the first and second columns.

7. The system according to claim 6, wherein the computer processor is further configured to:
prepare the visual content for display by processing the visual content from raw data into separate sets of objects each representing a line of content for display.

8. The system according to claim 7, wherein the computer processor is further configured to:
store the separate sets of objects in the memory.

9. The system according to claim 8, wherein the visual content has a top and a bottom, and wherein the each set of objects enables access to a piece of the visual content that occurs at a specific distance from the top of the visual content.

10. The system according to claim 7, wherein the number of lines are stored as a line variable in the memory.

11. A non-transitory computer-readable medium storing computer executable instructions for displaying and editing visual content, by a computer processor executing the instructions, the non-transitory computer-readable medium comprising code to:
store the visual content in a memory; and
display the visual content on a graphical user interface in at least a first and a second column, the visual content from the first column continuing in the second column;
wherein, when a user scrolls up the visual content data displayed in the first column on the graphical user interface, a computer processor causes the visual content displayed in the second column to dynamically change to begin appearing at the bottom of the first column such that continuity of the visual content is maintained between the first and second columns.

12. The non-transitory computer-readable medium of claim 11, further comprising code to prepare the visual content for display by processing the visual content from raw data into separate sets of objects each representing a line of content for display.

13. The non-transitory computer-readable medium of claim 12, further comprising code to store the separate sets of objects in the memory.

14. The non-transitory computer-readable medium of claim 13, wherein the visual content has a top and a bottom; and wherein the each set of objects enables access to a piece-of the visual content that occurs at a specific distance from the top of the visual content.

15. The non-transitory computer-readable medium of claim 12, further comprising code to store the number of lines as a line variable in the memory.
